(19) United States
(12) Patent Application Publication
(10) Pub. No.: US 2024/0367913 A1
(43) Pub. Date: Nov. 7, 2024

(54) FOOD RECEPTACLE SYSTEM FOR MEAL PRODUCTION

(71) Applicant: Sweetgreen, Inc., Los Angeles, CA (US)

(72) Inventors: Layne S. Whitaker, Waltham, MA (US); Braden E. Knight, Somerville, MA (US); Jessica Gwozdz, Winthrop, MA (US); Joseph McCabe, Arlington, MA (US)

(73) Assignee: Sweetgreen, Inc., Los Angeles, CA (US)

(21) Appl. No.: 18/652,229

(22) Filed: May 1, 2024

Related U.S. Application Data
(60) Provisional application No. 63/499,537, filed on May 2, 2023.

(51) Int. Cl. B65G 15/30

(52) U.S. Cl. CPC B65G 15/30; B65G 2201/0202; B65G 2201/0235

(57) ABSTRACT

A meal receptacle holder for a meal production system may include a shell configured to receive and support a meal receptacle a chassis configured to be operatively coupled to a track such that the shell moves along the track in a first degree of freed, and an actuator operatively coupled to the chassis and the shell, where the actuator is configured to move the shell in a second degree of freedom different than the first degree of freedom.

### RELATED APPLICATIONS

This application claims priority under 35 U.S.C. § 119 (e) to U.S. Provisional Application No. 63/499,537, filed May 2, 2023, the content of which is incorporated by reference in its entirety for all purposes.

### FIELD

Disclosed embodiments are related to a meal production system and related methods of use, and in particular a food receptacle system for a meal production system and related methods of use.

### BACKGROUND

Food handling and cooking has been traditionally performed by humans. In some cases, robotic systems have attempted to emulate aspects of human cooking, but such systems have been slower than human cooks or have other drawbacks.

### SUMMARY

In some aspects, the techniques described herein relate to a meal receptacle holder for a meal production system, including a shell configured to receive and support a meal receptacle, a chassis configured to be operatively coupled to a track such that the shell moves along the track in a first degree of freedom, and an actuator operatively coupled to the chassis and the shell, where the actuator is configured to move the shell in a second degree of freedom different than the first degree of freedom.

In some aspects, the techniques described herein relate to a meal production system including a plurality of meal receptacle holders, where each of the plurality of meal receptacle holders includes a shell configured to receive and support a meal receptacle, and an actuator operatively coupled the shell, where the actuator is configured to move the shell in a first degree of freedom, and a track supporting the plurality of meal receptacle holders, where the track is configured to move the plurality of meal receptacle holders along the track in a second degree of freedom different than the first degree of freedom.

In some aspects, the techniques described herein relate to a method of operating a meal production system, including moving a shell configured to receive and support a meal receptacle in a first direction in a first degree of freedom along a track to align the shell with a meal ingredient dispenser, and moving the shell with an actuator in a second degree of freedom different than the first degree of freedom while the shell is aligned with the meal ingredient dispenser.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a side schematic of one embodiment of a meal production system;

FIG. 2A is side schematic of one embodiment of a meal receptacle;

FIG. 2B is a top schematic of the meal receptacle of FIG. 2A;

FIG. 3 is a top schematic of another embodiment of a meal receptacle;

FIG. 4 is a first side schematic of an embodiment of a meal receptacle holder of a meal production system;

FIG. 5 is a second side schematic of the meal receptacle holder of FIG. 4;

FIG. 6A is a top schematic of the meal receptacle holder of FIG. 4 in a first state of an embodiment of a meal production process;

FIG. 6B is a top schematic of the meal receptacle holder of FIG. 4 in a second state of an embodiment of a meal production process;

FIG. 6C is a top schematic of the meal receptacle holder of FIG. 4 in a third state of an embodiment of a meal production process;

FIG. 6D is a top schematic of the meal receptacle holder of FIG. 4 in a fourth state of an embodiment of a meal production process;

FIG. 6E is a top schematic of the meal receptacle holder of FIG. 4 in a fifth state of an embodiment of a meal production process;

FIG. 6F is a top schematic of the meal receptacle holder of FIG. 4 in a sixth state of an embodiment of a meal production process;

FIG. 7 is a flow chart for an embodiment of a method of operating a meal production system;

FIG. 8 is a first side schematic of an embodiment of a charger of a meal production system;

FIG. 9 is a second side schematic of the charger of FIG. 8;

FIG. 10A is a side schematic of the charger of FIG. 8 and a meal receptacle holder in a first state of an embodiment of a meal production process;

FIG. 10B is a side schematic of the charger of FIG. 8 and a meal receptacle holder in a second state of an embodiment of a meal production process;

FIG. 11 is a flow chart for an embodiment of a method of operating a meal production system; and

FIG. 12A is a top schematic of an embodiment of a meal receptacle holder in a first state of an embodiment of a meal production process; and

FIG. 12B is a top schematic of the meal receptacle holder of FIG. 12A in a second state of an embodiment of a meal production process.

### DETAILED DESCRIPTION

Take out or fast food from quick service restaurants is a staple of many diets around the world. Quick service restaurants may spend a significant percentage of their revenue on labor costs. These operating costs may prevent restaurants from being able to sell fast, convenient meals at affordable prices or have a negative impact on operating margins. A significant portion of employee time in food service may involve placing meal ingredients on a meal receptacle (e.g., a plate or bowl) for final delivery to a consumer.

In view of the above, the inventors have recognized the benefits of an automated meal production system that enables automatic preparation of meal orders, including custom meal orders. The inventors have recognized the benefits in automating plating, including positioning one or more meal ingredients in specific regions of a meal receptacle for aesthetic, customization, and/or flavoring reasons. In particular, the inventors have appreciated the benefits of a meal receptacle holder providing at least two degrees of freedom for a meal receptacle. Aspects of such an automated meal production system described herein relate to automated systems for positioning portions of food that may constitute a meal or a portion of a larger meal.

In some embodiments, a meal receptacle holder may include a chassis and a shell supported by the chassis. The chassis may be configured to be moved along a track by a meal production system, and accordingly may be operatively coupled to the track. The shell may be configured to support a meal receptacle such as a bowl, plate, tray, etc. In some embodiments, the shell may include one or more flats or other features configured to engaged corresponding flats or other features on a meal receptacle so that torque may be transmitted between the meal receptacle and the shell. In such an arrangement a relative orientation of the meal receptacle within the shell may be ensured once the meal receptacle is received by the shell. In some embodiments, the meal receptacle holder may include an actuator disposed on the chassis configured to move the shell in a second degree of freedom different than the first degree of freedom. For example, in some embodiments the actuator may be configured to rotate the shell (e.g., in a rotational degree of freedom). As another example, in some embodiments the actuator may be configured to move the shell in a direction perpendicular to a direction of motion of the track (e.g., a translational degree of freedom). In some embodiments, the shell may be cantilevered from the chassis, such that the chassis is not disposed underneath the shell. Such an arrangement may help to avoid contamination of the chassis in the case of food spillage. In some embodiments, the actuator may be disposed in a chassis, and a transmission may be employed to transmit force from the actuator to the shell to move the shell in the second degree of freedom. According to exemplary embodiments herein, an arrangement where a meal receptacle may be moved in two degrees of freedom may allow for plating of various meal ingredients at desired positions within a meal receptacle. One or more meal ingredients may be targeted and dispensed into a meal receptacle region by moving the meal receptacle in the two degrees of freedom without moving the meal ingredient dispenser.

In addition to the above, the inventors have appreciated that conventional holders on track systems are unpowered in the sense that power and/or data signals do not pass from the track to the holder. In many cases, the inventors have appreciated that it is difficult to transfer power and/or data to a moving holder on a track system. Brushes, contact shoes, pantographs or other arrangements for transfer of power to a holder on a track may be complex and/or unreliable, in some circumstances. Accordingly, the inventors have appreciated the benefits of a meal receptacle holder for a track system that has an onboard power source that may be selectively recharged by a meal production system. The meal receptacle holder may accordingly have onboard actuators, sensors, and/or controllers powered by the onboard power source without the need for complex hardwired power and/or signal transfer between the meal production system and the meal production holder. The inventors have also appreciated the benefits of a meal receptacle holder that may communicate with other component of a meal production system wirelessly, such that actions of the various components of the meal production system may be coordinated (e.g., the dispensing of ingredients to form a meal in a meal receptacle).

In some embodiments, a meal receptacle holder includes a chassis configured to be moved along a track. The chassis may include a power source, such as a capacitor or battery. The meal receptacle may include one or more of an actuator, sensor, processor, transceiver, or other components configured to consume electrical energy. The power source may supply the power for the components on the chassis, such that the components do not receive any power from outside of the chassis. The chassis may also include at least one contact surface configured to receive a charger surface from a charger. The at least one contact surface may be connected to the power source (e.g., via a charge controller), and may receive electrical energy from the at least one charger surface that is used to charge the power source. Accordingly, the at least one charger surface and the at least one contact surface are configured to make an electrical connection. In some embodiments, the at least one charger surface of the charger may be configured to move between an engaged position and a disengaged position. For example, in some embodiments, a charger may include an actuator configured to move the at least one charger surface between an engaged position and a disengaged position. In some embodiments, the actuator may be configured to move the at least one charger surface in a direction perpendicular to the track (e.g., in a translational direction). In some embodiments, the at least one charger surface may move linearly between the engaged position and the disengaged position. In some embodiments, the charger may be positioned at a charging position on the track. Once the meal receptacle holder reaches the charging position, the meal receptacle holder may stop. Once stopped in the charging position, the at least one charger surface may move from the disengaged position to the engaged position to contact the at least one contact surface on the chassis. In this manner, the charger may be employed to charge the power source onboard the chassis.

In some embodiments, a meal production system may include a track including a plurality of meal receptacle holders, where the track moves the meal receptacle holders along the track. The meal receptacle holders may be movable in a first degree of freedom in two track directions along the track: forward and backward. A meal receptacle may be placed on a meal receptacle holder to be correspondingly moved along the track. The meal production system may also include at least one meal ingredient dispenser positioned above the track. To facilitate dispensing a meal ingredient from at least one meal ingredient dispenser, the system may locate the meal receptacle at a position where an assigned region of the meal receptacle is aligned with a meal ingredient dispenser. With the meal receptacle at the correct position, the at least one meal ingredient dispenser may then be controlled to dispense the meal ingredient associated with the meal ingredient dispenser into the aligned region of the meal receptacle. In some cases, the meal receptacle holder may move the meal receptacle in a second degree of freedom, such that a meal ingredient may be dispensed into multiple regions of the meal receptacle, or different regions may be targeted by the meal production system. In this manner, a meal ingredient can be assigned to one or more physical or virtual regions of a meal receptacle and be dispensed into those assigned regions to form a completed meal. By enabling positioning of meal ingredients in a meal receptacle, a meal may be more customizable, have enhanced aesthetics, and/or enhanced flavoring relative to conventional meal production systems.

In some embodiments, a meal production system may include a track having a plurality of meal receptacle holders, where the track moves the meal receptacle holders along the track. The meal production system may include at least one meal ingredient dispenser positioned above the track, where the at least one meal ingredient dispenser is configured to dispense a meal ingredient into a meal receptacle positioned on one of the meal receptacle holders. In some embodiments, the meal receptacle holder may be configured to rotate the meal receptacle while the meal receptacle is aligned with the at least one meal ingredient dispenser. As a result, when the meal ingredient is dispensed the rotational motion may spread the meal ingredient evenly throughout the meal receptacle. Accordingly, the meal ingredient may not significantly stack up, and may instead be distributed evenly through one or more regions of the meal receptacle. In some embodiments, the meal production system may be configured to stop a meal receptacle in a position aligned with the at least one meal ingredient dispenser. Once stopped, the meal ingredient may be dispensed into to the meal receptacle. After the meal ingredient is dispensed, the meal receptacle holder may rotate the meal receptacle to spread the meal ingredient throughout the meal receptacle. Of course, a meal receptacle holder may rotate a meal receptacle before, during, or after dispensing a meal ingredient, as the present disclosure is not so limited.

According to exemplary embodiments described herein, one or more meal ingredient dispensers may be employed to dispense meal ingredients into a meal receptacle. The meal ingredient dispensers may be configured to dispense solids, semi-solids, or liquid meal ingredients. Additionally, the meal ingredient dispensers may be configured to dispense hot ingredients, cold ingredients, or room temperature ingredients. A meal ingredient dispenser may dispense raw ingredients and/or prepared ingredients. For example, a meal ingredient dispenser may dispense proteins, vegetables, grains, fruit, toppings, which are in raw form or pre-prepared. The meal ingredient dispensers according to exemplary embodiments described herein may be configured to dispense a predetermined volume or weight of a meal ingredient, depending at least partly on a custom order from a user. That is, a user may select a meal ingredient, an amount of the meal ingredient, and a specific region of a meal receptacle into which the meal ingredient is dispensed based on a recipe or custom input. For example, a user may request a meal containing three meal ingredients, where each meal ingredient is configured to be dispensed from a corresponding meal ingredient dispenser in a chosen or predetermined volume. In some embodiments, a meal ingredient dispenser may include at least two gates configured to separate a portion volume of a meal ingredient from a bulk volume of the meal ingredient, allowing the portion to fall into a meal receptacle. In some embodiments, a meal ingredient dispenser may be formed as a hopper including a rotating paddle wheel or auger configured to release ingredients that fall by gravity into a meal receptacle. In other embodiments, a meal ingredient dispenser may be a liquid meal ingredient dispenser that uses a pump to dispense a liquid meal ingredient (e.g., a sauce) into a meal receptacle. Of course, any suitable dispenser may be employed to dispense one or more meal ingredients into a meal receptacle positioned on a track, as the present disclosure is not so limited.

According to exemplary embodiments described herein, a track may be employed to convey one or a plurality of meal receptacle holders along a path. In particular, the track may be configured to move a meal receptacle holder underneath a plurality of meal ingredient dispensers that may each contain a meal ingredient that can be dispensed into a meal receptacle positioned on one of the meal receptacle holders. Where a plurality of meal receptacle holders is employed, the track may be configured to move at least some of the meal receptacle holders independently. That is, a first meal receptacle holder may be moved forward, backward, or stopped independent of a second meal receptacle holder. In some embodiments, the track may be configured as a magnetic conveyor that allows two or more of the meal receptacle holders to be moved independently in this manner. In other embodiments, the track may be formed as a conveyor belt or similar track configured to move a plurality of meal receptacle holders at the same time. Of course, any suitable track and meal receptacle holders may be employed in a meal production system, as the present disclosure is not so limited.

According to exemplary embodiments described herein, a meal production system may be configured to assemble a meal in a meal receptacle. That is, the meal production system of exemplary embodiments herein may be configured to dispense one or more meal ingredients into a meal receptacle. In some embodiments, a meal receptacle may be configured as a bowl. The bowl may be virtually divided into one or more regions, where a particular region may be assigned to receive a meal ingredient. In other embodiments, a meal receptacle may be configured as a plate. The plate may also be virtually divided into one or more regions, one or more of which may be assigned to receive certain meal ingredients. In some embodiments, a meal receptacle may include one or more physically divided regions. For example, a meal receptacle (e.g., a tray) may include one or more walls dividing two or more food receiving regions. Like virtual regions, a physically divided region may also be assigned to receive specific meal ingredients depending on a meal order submitted to the meal production system. Of course, any suitable meal receptacle may be employed with one or more meal ingredient receiving regions that are virtually or physically defined, as the present disclosure is not so limited.

In some embodiments, a meal production system may be configured to receive an order from one or more users, and subsequently the meal production system may prepare the ordered meal. A meal production system may receive an input from one or more users at one or more input devices. Representative input devices may be tablets, point-of-sale devices, mobile devices (e.g., smartphones), personal computers (e.g., desktops, laptops, etc.), or any other suitable input device. The one or more input devices may be located near the meal production system (e.g., in the same building or room), or may be remotely located. The one or more input devices may communicate wirelessly or wired with a controller of the meal production system that may control one or more components of the meal production system. At the one or more input devices a user may be able to select one or more meal ingredients to form a meal. In some embodiments, the user may select independent meal ingredients and custom quantities of those ingredients. In some embodiments, the user may select from a plurality of predetermined recipes which specify meal ingredients in predetermined quantities. In some embodiments, the user may select from a plurality of predetermined recipes, and further customize those recipes by increasing quantity of ingredients (e.g., selecting extra protein) or selecting add-ons (e.g., toppings, sides, etc.). According to exemplary embodiments described herein, each meal ingredient may be assigned to one or more regions of a meal receptacle. Some recipes may include predetermined assigned regions. However, in some embodiments, the assigned regions of a meal ingredient may be customized or selected by a user. For example, a user may elect one or more meal ingredient to be “on the side” and placed in a region that is different than the predetermined region that the meal ingredient is normally assigned. Thus, depending on a particular order received at one or more use input devices, a meal production system may assign one or more meal ingredients to one or more regions of a meal receptacle. Accordingly, when the meal is assembled by the meal production system, the assigned meal ingredients may be deposited in the corresponding assigned regions. While in some embodiments a user may be customer, in other embodiments the user may be an employee (e.g., chef, cashier, waiter, etc.) or any other suitable user, as the present disclosure is not so limited. In some embodiments, a first user (e.g., a customer) may submit an order, and a second user (e.g., an employee) may alter the order.

According to exemplary embodiments described herein, a meal production system may be operated by a controller. The controller may include one or more processors configured to execute computer readable instructions stored in volatile or non-volatile memory. The controller may communicate with one or more actuators associated with various elements of the meal production system (e.g., track, meal ingredient dispensers, etc.) to control movement of the various elements. The controller may receive information from one or more sensors that provide feedback regarding the various elements of the meal production system. For example, the controller may receive position information regarding a meal receptacle holder. In this manner, the controller may implement proportional control, integral control, derivative control, or a combination thereof (e.g., PID control). Of course, other feedback control schemes are contemplated, and the present disclosure is not limited in this regard. Any suitable sensors in any desirable quantities may be employed to provide feedback information to the controller. Accelerometers, rotary encoders, potentiometers, optical sensors, and cameras may be employed in coordination with desirable processing techniques (e.g., machine vision). The controller may also communicate with other controllers, computers, or processors on a local area network, wide area network, or internet using an appropriate wireless or wired communication protocol. In some embodiments, a controller may execute computer readable instructions based at least in part on input from a user. For example, a controller may receive a recipe or custom order including a series of actions to be executed by the meal production system. The controller may execute the instructions based at least partly on the recipe or custom order to prepare a meal.

According to exemplary embodiments described herein, various elements of a meal production system may be movable with one or more actuators. That is, various elements may include one or more actuators that provide one or more corresponding degrees of freedom. Actuators that control elements such as meal dispensers and meal receptacle holders may include any suitable electromechanical, pneumatic, or hydraulic actuator. For example, actuators for use with exemplary embodiments described herein may include DC motors, stepper motors, brushless motors, servos, stepper motors with lead screws, linear actuators, rigid chain actuators, pneumatic linear actuators, hydraulic linear actuators, and others. As noted previously, actuators of exemplary embodiments described herein may be connected or otherwise controlled by a controller.

As used herein, “dispensing” refers to depositing a solid, semi-solid, or liquid meal ingredient in a meal receptacle. “Dispensing” may also be referred to as “dropping” or “placing,” in some embodiments.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

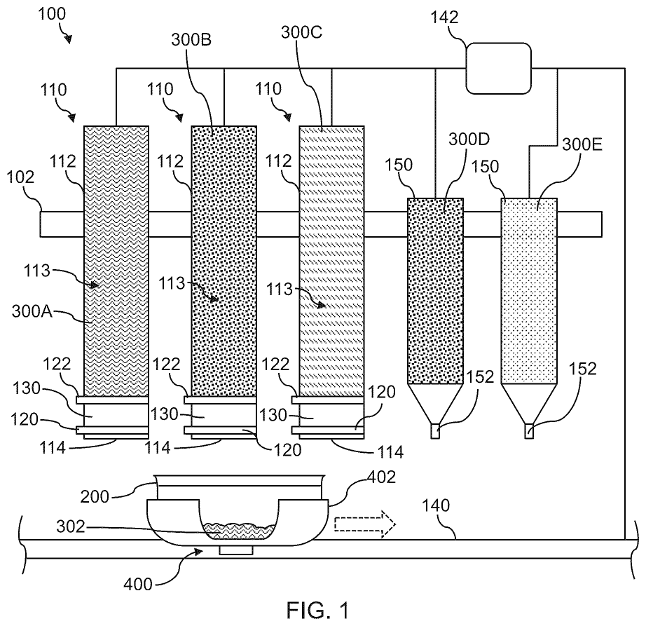

FIG. 1 is a side schematic of one embodiment of a meal production system 100 including a plurality of solid meal ingredient dispensers 110 and liquid meal ingredient dispensers 150. As shown in FIG. 1, the meal production system includes a superstructure 102 configured to support each of the meal ingredient dispensers 110, 150 as well as a track 140. According to the embodiment of FIG. 1, each of the solid meal ingredient dispensers 110 includes a housing 112 including an interior volume 113 configured to contain a solid meal ingredient. In particular, the three meal ingredient dispensers include a first meal ingredient 300A, a second meal ingredient 300B, and a third meal ingredient 300C, respectively. Each of the housings 112 includes an outlet 114 through which the meal ingredient is configured to be dispensed. The solid meal ingredient dispensers also include first gates 120 positioned adjacent to the outlets 114, and second gates 122 positioned in the interior volume 113 above the first gates 120. That is, the first gates 120 are positioned between the second gates 122 and the outlets 114. Each pair of the first gates and second gates defines a portion volume 130 therebetween. The portion volume is sized and shaped to receive a predetermined volume of the meal ingredient to form a meal ingredient portion that may be dispensed onto a meal receptacle 200. According to the embodiment of FIG. 1, the first gates 120 and second gates 122 may be configured to move between open positions where the meal ingredients are free to move toward the outlets 114, and closed positions where the gates block movement of the meal ingredient towards the outlets. That is, the first gates and second gates may be configured to selectively divide the interior volume 113 of each meal ingredient dispenser 110.

In the embodiment of FIG. 1, the liquid meal ingredient dispensers 150 are configured to dispense a liquid such as a sauce. As shown in FIG. 1, the three liquid meal ingredient dispensers are configured to dispense a fourth meal ingredient 300D and a fifth meal ingredient 300E, respectively. The liquid meal ingredient dispensers each include a nozzle 152. The nozzles may include a valve (e.g., a solenoid valve) configured to control flow of a liquid meal ingredient contained in the liquid meal ingredient dispenser. For example, the valve may be configured to move between a closed position where liquid is not able to flow out of the liquid meal ingredient dispenser 150 and an open position where liquid is able to flow out of the liquid meal ingredient dispenser. In some embodiments, a liquid contained in the liquid meal ingredient dispensers may be driven from the corresponding nozzles by way of gravity. In other embodiments, a pump may be employed to assist in driving the fluid from the outlet. Of course, any suitable dispensing arrangement may be employed for a liquid meal ingredient dispenser, as the present disclosure is not so limited.

As shown in FIG. 1, the meal production system includes a track 140 which support one or more meal receptacle holders 400 on the track. The meal receptacle holders 400 include a shell 402 configured to support a meal receptacle 200 and move the meal receptacle along the track 140 in the direction shown by the dashed arrow. In some embodiments, the meal receptacle holder 400 may be controlled independently of any other meal receptacle holder positioned on the track. In such an embodiment, the track 140 may be configured as a magnetic conveyor. Meal receptacles holders 400 may move in a coordinated manner with other meal receptacle holders in other embodiments, as the present disclosure is not so limited. As shown in FIG. 1, the meal receptacle holder 400 includes a shell 402 configured to support a meal receptacle 200 which is configured as a bowl. As the meal receptacle holder moves the meal receptacle along the track 140, the meal receptacle may be configured to receive one or more meal ingredient portions from the solid meal ingredient dispensers 110 or the liquid meal ingredient dispensers 150. For example, as shown in FIG. 1, the meal receptacle has received a first meal ingredient portion 302. According to the embodiment of FIG. 1, when the meal receptacle 200 is in a position aligned with one or more of the meal ingredient dispensers 110, the first gates of the one or more meal ingredient dispensers may be opened to dispense a meal ingredient portion through the outlet 114 and onto the meal receptacle. In some embodiments, the meal receptacle holder 400 may stop or slow the meal receptacle 200 at a position associated with one or more of the meal ingredient dispensers to allow a meal ingredient portion to be dispensed onto the meal receptacle, and in some cases, into a specific region of a meal receptacle.

According to the embodiment of FIG. 1, the meal production system 100 is controlled by a controller 142, which may include one or more processors configured to execute computer readable instructions stored in volatile or non-volatile memory. As shown in FIG. 1, the controller 142 is connected to each of the solid meal ingredient dispensers 110 and the liquid meal ingredient dispensers 150. The controller may coordinate the dispensing of meal ingredients from each of the dispensers. For example, the controller may command one of the solid meal ingredient dispensers 110 to move the first gate from the closed position to the open position to dispense a meal ingredient from the first meal ingredient dispenser. As another example, the controller may command one of the liquid meal ingredient dispensers 150 to open a nozzle 152 to dispense a liquid meal ingredient. The controller 142 is also connected to the track 140 and is configured to control the position, velocity, and acceleration of one or more meal receptacle holders 400. The controller may coordinate the motion of multiple meal receptacles to avoid collisions between the meal receptacles and/or meal receptacle holders. In some embodiments, the controller may coordinate motion of the meal receptacle holder 400 based at least partly on an order received from a user, who may input the order at one or more user input devices.

According to the embodiment of FIG. 1, the meal receptacle holder 400 is cantilevered from the track 140. In this manner, components of the track 140 are not in a dispensing path of the meal ingredient dispensers, and if meal ingredients were to be dispensed outside of the meal receptacle inadvertently, the meal ingredients would not contact the track, which is an event which could potentially jam or damage the track. Of course, any suitable track configuration may be employed, including tracks positioned under the meal receptacles, as the present disclosure is not so limited.

Although the meal production system illustrated in FIG. 1 includes three solid meal ingredient dispensers and two liquid meal ingredient dispensers, it should be noted that any suitable number of meal ingredient dispenser may be employed with a meal production system. That is, a meal production system may include any number of solid or semi-solid meal ingredient dispensers that may dispense, cold, hot, or room temperature ingredients into a meal receptacle. Likewise, a meal production system may include any number of liquid meal ingredient dispensers that dispense cold, hot, or room temperature liquid ingredients into a meal receptacle.

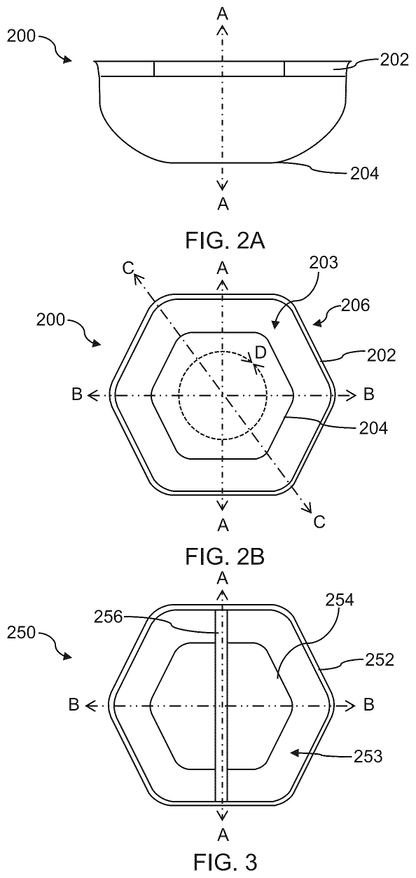

FIG. 2A is side schematic and FIG. 2B is a top schematic of one embodiment of a meal receptacle 200. According to the embodiment of FIGS. 2A-2B, the meal receptacle is configured as a bowl. The meal receptacle includes a rim 202 that, in some embodiments, may be used by a meal receptacle holder to hold the meal receptacle in a meal production system. The meal receptacle also includes a base 204 that, in some embodiments, may be used by a meal receptacle holder to hold the meal receptacle in a meal production system. In some embodiments as shown in FIGS. 2A-2B, the meal receptacle may be a hexagonal bowl, such that the bowl includes six flats 206. The flats may be configured to engage corresponding flats of a meal receptacle holder, such that torque may be transmitted between the meal receptacle and the meal receptacle holder. Accordingly, in some embodiments as discussed herein, a meal receptacle holder may rotate the meal receptacle. In some embodiments, the flats 206 may ensure that the meal receptacle is received and held in a meal receptacle holder in a known orientation. In some embodiments, a meal receptacle holder and a meal receptacle may be keyed to one another such that the meal receptacle holder received the meal receptacle in a single orientation. Such embodiments may be desirable in cases where a meal receptacle is not rotationally symmetrical, for example, where a meal receptacle has a region defined by a physical boundary. In other embodiments as shown in FIGS. 2A-2B, a meal receptacle may have rotational symmetry (e.g., order six rotational symmetry in the case of a hexagon), so that the meal receptacle may be received in any rotational orientation by a meal receptacle holder and may be aligned with the flats 206. While a hexagonal meal receptacle is shown in FIGS. 2A-2B, other shapes may be employed, including round, square, D-shaped, pentagonal, octagonal, and other shapes. In some embodiments, a meal receptacle may not have flats, and torque may be transmitted between a meal receptacle and a meal receptacle holder by friction. In such an embodiment, a meal receptacle may be circular or otherwise round.

As shown in FIGS. 2A-2B, the meal receptacle may include a plurality of virtual boundaries dividing the meal receptacle into a plurality of regions. In the specific embodiment of FIGS. 2A-2B, the meal receptacle 200 is divided into twelve distinct regions, each of which may be assigned to receive a specific meal ingredient depending on a particular recipe or custom order. As shown in FIGS. 2A-2B, the regions are defined by boundaries A-A, B-B, C-C, and D-D which form virtual walls for an interior volume 203 of the meal receptacle 200. As shown in FIG. 2B, the boundaries A-A, B-B, and C-C may be planes that bisect the interior volume 203 through a center of the meal receptacle. That is, each of the boundaries A-A, B-B, and C-C separates the interior volume 203 into two regions. In some embodiments, the planes may be angularly spaced from one another to create regions that are sectors of the interior volume 203. For example, the boundaries A-A and B-B are perpendicular to one another, such that the interior volume is split into four sectors (e.g., quadrants) by those planes. Boundary C-C may be angled approximately 60 degrees from boundary B-B, and 30 degrees from boundary A-A. Accordingly, the boundary C-C further divides the interior volume 203 into additional sectors having different angular sizes. In some embodiments, all sectors may have an equal size. In some embodiments, a meal receptacle may have an interior volume divided into two, four, six, eight, ten, or any other numbers of regions formed as sectors of equal or different angular sizes. In some embodiments, regions of a meal receptacle may be arrayed in at least one column and at least one row in a two-dimensional plane. In some embodiments, the columns may correspond to a first degree of freedom (e.g., the meal receptacle may be moved in the first degree of freedom to align a column with a meal ingredient dispenser). In some embodiments, the rows may correspond to a second degree of freedom (e.g., the meal receptacle may be moved in the second degree of freedom to align a row with a meal ingredient dispenser).

In some embodiments as shown in FIG. 2B, a boundary may be non-planar. For example, boundary D-D is circular, and divides the interior volume 203 of the meal receptacle 200 into a circular and annular region. Such an arrangement may be desirable where the meal receptacle is rotatable by a meal receptacle holder. In such embodiments, the inventors have appreciated that it may be desirable to plate meal ingredients in a center of a meal receptacle or an outer ring of the meal receptacle. In such instances, a boundary like that of D-D may be employed to create additional regions within the interior volume 203 of the meal receptacle.

It should be noted that while the meal receptacle 200 of FIGS. 2A-2B includes four boundaries A-A, B-B, C-C, and D-D, a meal receptacle may have any suitable number of boundaries. The boundaries may form any suitable number of regions, including, but not limited to, two regions, three regions, four regions, five regions, six regions, seven regions, and eight regions, as the present disclosure is not so limited. Furthermore, regions may be similarly sized or have different sizes as appropriate for a given recipe or custom order.

According to the embodiment of FIGS. 2A-2B, the virtual boundaries A-A, B-B, C-C, and D-D of the meal receptacle 200 may be optionally assigned based at least partly on a particular meal recipe or custom order. For example, if an order calls for a mixed bowl or salad where all meal ingredients are mixed together, no virtual boundaries may be assigned to the meal receptacle. As another example, if a user requests a meal ingredient on the side, a virtual boundary creating a region for that meal ingredient may be assigned to the meal receptacle. Accordingly, for a given meal receptacle 200, any number of virtual boundaries may be assigned dynamically by a controller depending on user inputs or predetermined recipes. In this manner, numerous plated meals having meal ingredients in distinct regions of the meal receptacle may be prepared by a meal production system according to exemplary embodiments described herein, even where the meal receptacle itself is unchanged.

FIG. 3 is a top schematic of another embodiment of a meal receptacle 250. As shown in FIG. 3, the meal receptacle is like that of FIGS. 2A-2B, insofar as the meal receptacle 250 is configured as a bowl including a rim 252 and a base 254 that may be used by a meal receptacle holder to hold the meal receptacle. However, in contrast to the embodiment of FIGS. 2A-2B, the meal receptacle 250 of FIG. 3 includes a physical wall 256 positioned in an interior volume 253 of the meal receptacle. The physical wall 256 defines a boundary of a region to the left of boundary A-A relative to the page. Accordingly, if the regions of the meal receptacle 250 are defined solely by the physical wall 256, a second region is positioned to the right of boundary A-A relative to the page. Thus, the physical wall 256 may define two regions configured to receive one or more meal ingredients. As shown in FIG. 3, the meal receptacle 250 may include additional virtual boundaries that define additional regions or otherwise subdivide existing physical or virtual regions. For example, boundary B-B may split each of the left and right regions defined by the wall 256 into two regions that may be assignable to specific meal ingredients, for a total of four regions. Accordingly, as shown in FIG. 3, the meal receptacle may be divided into four assignable regions via a combination of physical and virtual boundaries. Of course, any suitable number of virtual and physical boundaries may be employed to define any suitable number of regions of a meal receptacle for a particular meal. Additionally, in some embodiments, virtual or physical boundaries may not extend fully across a width or length of the meal receptacle, and the present disclosure is not so limited in this regard.

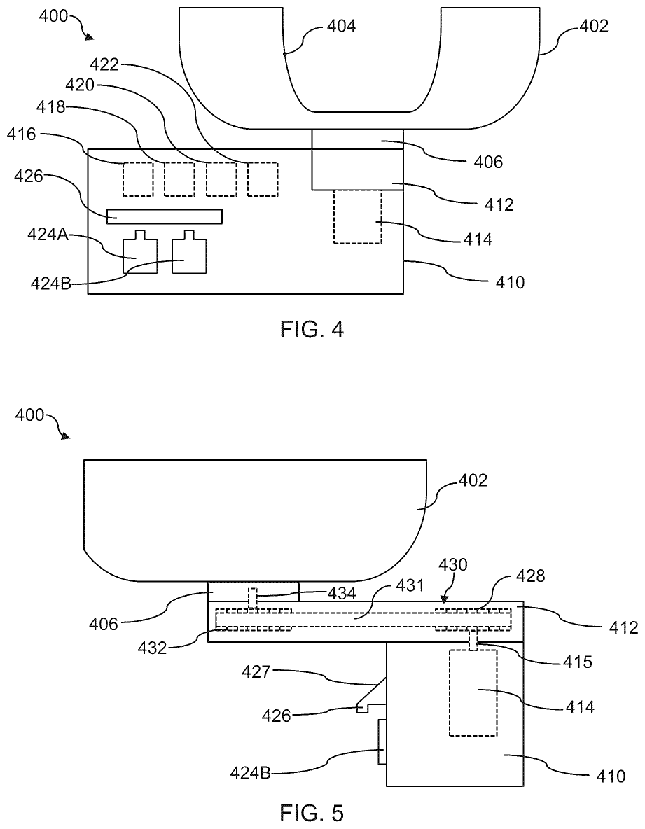

FIG. 4 is a first side schematic and FIG. 5 is a second side schematic of an embodiment of a meal receptacle holder 400 of a meal production system. The meal receptacle holder of FIGS. 4-5 may be configured to support a meal receptacle (for example, see FIGS. 2A-3) on a track of a meal production system. As shown in FIG. 4, the meal receptacle holder includes a shell 402 configured to receive and support a meal receptacle. In the embodiment of FIGS. 4-5, the shell 402 is configured to support a base and a lip of a meal receptacle. In other embodiments, a shell may support only a base, only a lip, or any portion of a meal receptacle, as the present disclosure is not so limited. As shown in FIG. 4, the shell 402 includes a cutout 404. The cutout 404 may be optional and may be employed to allow a user to more easily remove a meal receptacle from a meal receptacle holder. In some embodiments as shown in FIGS. 4-5, the shell 402 is supported by a chassis 410 by a cantilevered arm 412. Accordingly, as shown in FIG. 5, the shell 402 is spaced from the chassis 410 which may the chassis less likely to encounter spills of meal ingredients. In other embodiments, a shell may be disposed immediately above the chassis 410, as the present disclosure is not so limited.

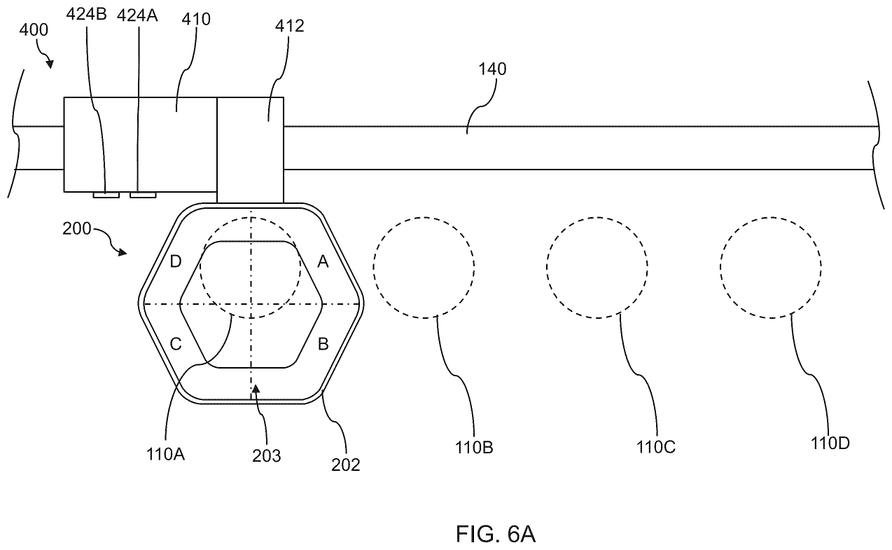

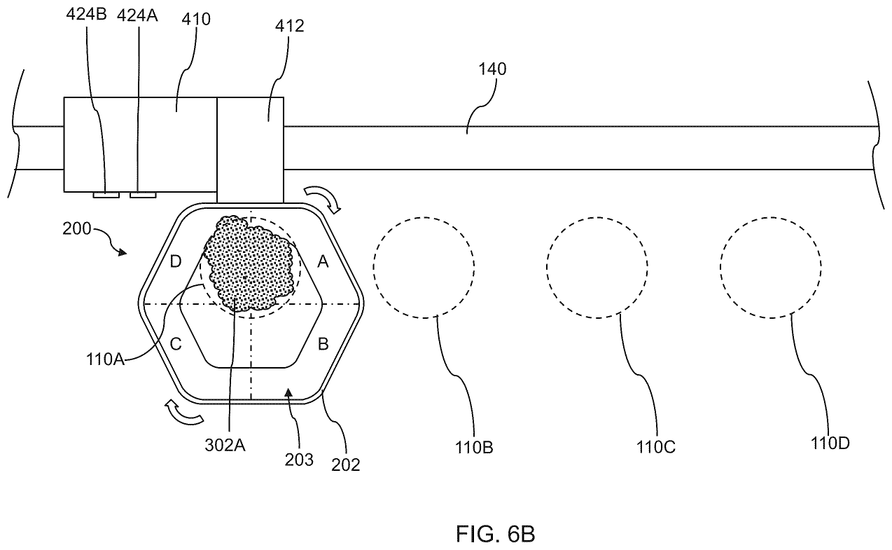

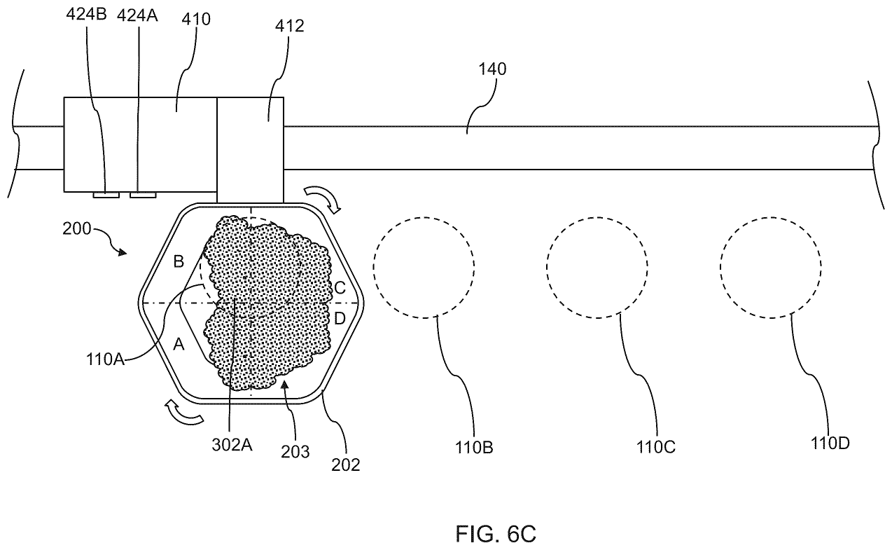

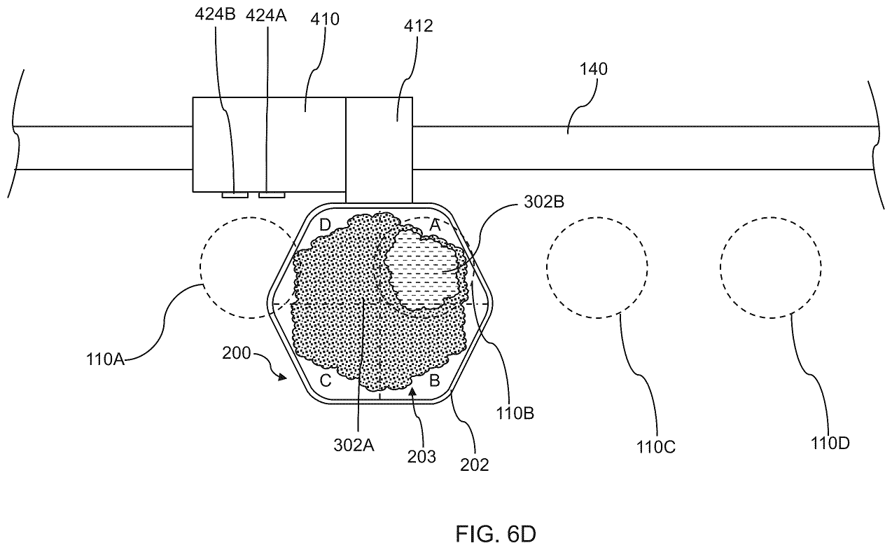

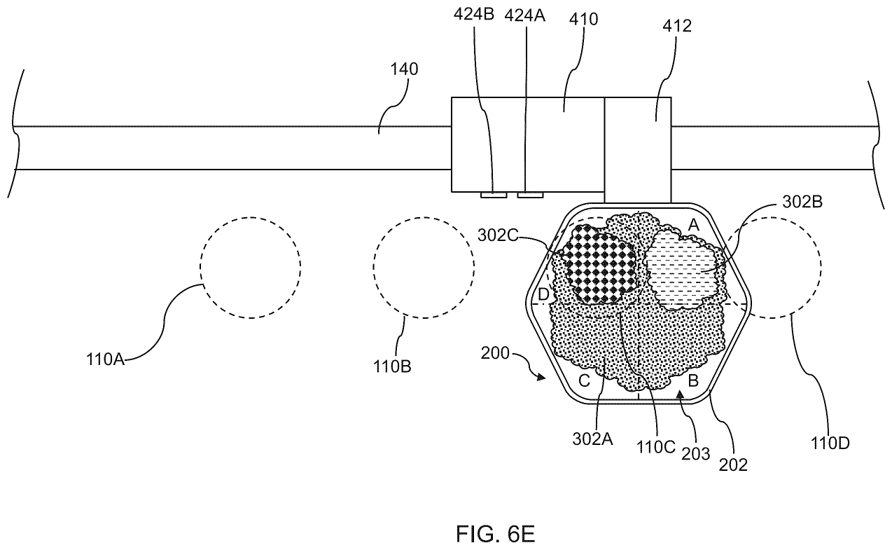

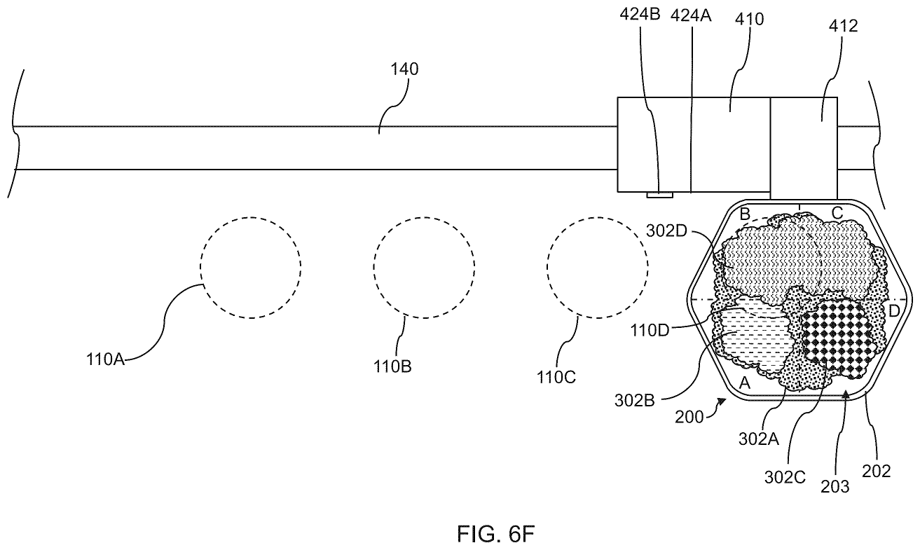

According to the embodiment of FIGS. 4-5, the meal receptacle holder is configured to move a meal receptacle in two degrees of freedom, so that regions within the meal receptacle within a two-dimensional plane may be targeted for dispensing meal ingredients. The chassis 410 of the meal receptacle holder in configured to be moved along a track in a first degree of freedom. The shell 402 is configured to move with the chassis in the first degree of freedom. Additionally, the meal receptacle holder 400 includes an actuator 414 disposed on the chassis and operatively coupled to the shell so that the actuator may move the shell 402 in a second degree of freedom. In the embodiment of FIGS. 4-5, the actuator 414 is configured to rotate the shell 402 so that the second degree of freedom is a rotational degree of freedom. By moving the chassis 410 along the track and rotating the shell 402, any region of the meal receptacle may be targeted for dispensing a meal ingredient from a static meal ingredient dispenser. An example of this functionality is discussed further with reference to FIGS. 6A-6F.

In some embodiments, the actuator 414 may be a motor, such as a DC motor, brushless motor, or stepper motor. In the embodiment of FIGS. 4-5, the actuator 414 may be configured as a servo. In some embodiments, the actuator may be configured to be controlled in feedback control (e.g., proportional, integral, derivative, or any combination thereof) to allow for accurate and precise movement of the shell 402 in the second degree of freedom. As shown in FIG. 5, the actuator 414 may include an output shaft 415 coupled to a transmission 430. The transmission may be disposed in the cantilevered arm 412. In some embodiments, the transmission may include a first gear 428, a second gear 432, and a belt 431. The transmission 430 may transmit the rotational motion of the output shaft 415 of the actuator 414 to a shell coupler 406 attached to the shell 402 via an output shaft 434 of the transmission 430. The output shaft 415 may be aligned with a first axis and the output shaft 434 may be aligned with a second axis parallel to the first axis. Accordingly, rotation of the output shaft 415 may rotate the shell 402 about the second axis. Use of a transmission as shown in FIG. 5 may simplify wiring and maintenance of the actuator 414. In other embodiments, an actuator may be disposed in the cantilevered arm 412, as the present disclosure is not so limited. For example, the actuator 414 may be directly coupled to the shell 402 or shell coupler 406 in some embodiments.

In some embodiments as shown in FIG. 4, a meal receptacle holder 400 may be controlled independently from a track. That is, the meal receptacle holder and track may both coordinate movements as a part of a meal production system, but the meal receptacle holder may not receive power or data from the track. As shown in FIG. 4, the meal receptacle holder may include a controller 416 (e.g., a processor) configured to control the actuator 414 and other components of the meal receptacle holder. The meal receptacle holder may also include a power source 418, which may be configured as a battery or capacitor and supplies electrical power to the various components of the meal receptacle holder such as the controller 416 and the actuator 414. The meal receptacle holder may also include a wireless transceiver 420, which may allow the controller 416 to receive and/or transmit commands or information to other controllers of a meal production system. For example, the meal receptacle holder 400 may receive commands via the transceiver from a meal production system to rotate the shell 402 at various locations along a track to prepare a meal, which is coordinated by the meal production system. In some embodiments, the meal receptacle holder may also include one or more sensors 422 configured to collect information that may be used in control of the actuator 414 and/or sent to meal production system. For example, a sensor may include a potentiometer or rotary encoder configured to collect rotational orientation information about the shell 402 so that the rotational orientation of the shell 402 may be determined by the controller 416 and/or the meal production system. Other sensors may be employed to collect information regarding the meal receptacle holder 400 or a meal receptacle, including accelerometers, temperature sensors, or others, as the present disclosure is not so limited.

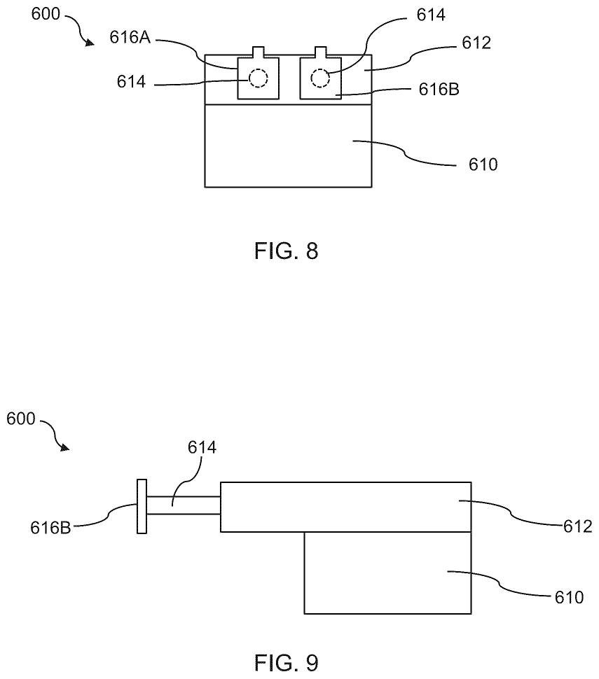

According to the embodiment of FIGS. 4-5, the meal receptacle holder 400 includes a power source 418 disposed onboard the chassis 410. The power source 418 may be only power source for the various components onboard the meal receptacle holder. That is, the meal receptacle holder may not be electrically connected to the track or another component of a meal production system during normal operation. Such an embodiment may simplify a track system for a meal production system and may further avoid use of brushes or other movable electrical connectors that may wear out may also be affected by food spillage. As the power source 418 is onboard the meal receptacle holder, the power source may be configured to be selectively recharged by the meal production system. In some embodiments as shown in FIGS. 4-5, the chassis 410 may include a first contact surface 424A and a second contact surface 424B (e.g., at least two contact surfaces). The first and second contact surfaces may be configured to receive corresponding charger surfaces that may form an electrical connection and allow the power source 418 to be recharged. In some embodiments, the power source 418 may be recharged at a dedicated charging position on a track. An exemplary embodiment of a charger will be discussed further with reference to FIGS. 8-10B. In some embodiments, a power source of a meal receptacle holder may be charged every cycle of a track or less frequently, depending on the power capacity of the meal receptacle holder. In some embodiments, a meal receptacle holder may be charged during non-operation of a meal production system. For example, meal receptacle holders may be charged overnight and used throughout the day. In some embodiments as shown in FIG. 5, a charge cover 426 may be disposed above the first contact surface 424A and the second contact surface 424B to inhibit falling food from contaminating the contact surfaces. In some embodiments, an inclined wall 427 of the cover may promote any food particles to fall away from the contact surfaces. In some embodiments no cover 426 may be employed.

It should be noted that while the meal receptacle holder 400 of FIGS. 4-5 is configured to be electrically independent from a track system, in some embodiments a meal receptacle holder may be electrically connected to a track system to provide data and/or power connections to the various components of the meal receptacle holder directly from a meal production system. In such embodiments, the meal receptacle holder may provide two degrees of freedom for a shell 402 but may optionally omit some components such as the power source 418, transceiver 420, and controller 416.

FIGS. 6A-6F depict side schematic views of a meal production system including the meal receptacle holder 400 of FIGS. 4-5 throughout a meal production process according to one embodiment. The meal receptacle holder 400 supports a meal receptacle 200 having a rim 202 and an interior volume 203. As shown in FIG. 6A, the interior volume 203 of the meal receptacle 200 is divided into four regions: a first region A, a second region B, a third region C, and a fourth region D. In the depicted embodiment, each of the regions is bounded by virtual boundary planes shown in dot-dash lines. As shown in FIG. 6A, the meal receptacle holder 400 includes a chassis 410 supporting a cantilevered arm 412. A shell disposed on the cantilevered arm is receiving and supporting the meal receptacle 200. As shown in FIG. 6A, the track 140 has moved the meal receptacle holder chassis 410, and correspondingly the meal receptacle 200, such that both the first region A and the fourth region D are aligned with a first meal ingredient dispenser 110A (shown in phantom for clarity). Specifically, in the example of FIG. 6A, the virtual boundary perpendicular to the track 140 is aligned on a center of the first meal ingredient dispenser 110A. As noted previously, the track 140, meal receptacle holder 400, and the first meal ingredient dispenser 110A may be controlled by one or more controllers, and in particular, by one or more processors executing computer readable instructions stored in volatile or non-volatile memory. In some embodiments, the motion of the chassis 410 on the track 140 (e.g., in a first degree of freedom) may be controlled by a track controller, and rotation of the meal receptacle (e.g., in a second degree of freedom), may be controller by a controller of the meal receptacle holder 400.

FIG. 6B is a top schematic of the meal receptacle holder 400 and a meal production system in a second state of an embodiment of a meal production process. As shown in FIG. 6B, a first meal ingredient portion 302A has been dispensed from the first meal ingredient dispenser 110A. The first meal ingredient portion 302A shown in FIG. 6B may be a single meal ingredient portion (e.g., from a portion volume) or may be a part of a meal ingredient portion. As shown in FIG. 6B, in some embodiments the chassis 410 may be stopped on the track 140 when the meal receptacle 200 is aligned with a meal ingredient dispenser assigned to dispense food into the meal receptacle for a particular meal order. While the chassis 410 is stopped in the first degree of freedom (e.g., along the track), the meal receptacle holder 400 may move the meal receptacle in a second degree of freedom to target specific regions of the meal receptacle (e.g., regions, A, B, C, and D). In the embodiment of FIG. 6B, the meal receptacle holder is configured to rotate the meal receptacle 200. In some embodiments, the meal receptacle may be rotated about an axis aligned with a geometric center of the meal receptacle. In some embodiments, the axis of rotation may be perpendicular to the track, and aligned in a vertical direction (e.g., a direction parallel to a direction of local gravity).

In some embodiments, the meal receptacle 200 may be moved in the second degree of freedom (e.g., rotated) to align one or more of the regions of the meal receptacle with a meal ingredient dispenser (e.g., first meal ingredient dispenser 110A). The meal receptacle may then be stopped, and a meal ingredient dispensed into the targeted region. In some embodiments as shown in FIG. 6B, the meal receptacle may be moved in the second degree of freedom while the meal receptacle 200 is moved in the second degree of freedom. For example, as depicted in FIG. 6B by the arrows, the meal receptacle may be rotated in a first direction in the second degree of freedom as the first meal ingredient portion 302A is dispensed into the meal receptacle. Such an arrangement may allow a meal ingredient to be spread across multiple regions of the meal receptacle 200. For example, in FIG. 6B the first meal ingredient portion 302A may be a beginning of a dispense from the first meal ingredient dispenser 110A. In FIG. 6B, the first meal ingredient portion 302A may be disposed in two regions: first region A and fourth region D. In FIG. 6C, during the same dispensing operation, the meal receptacle 200 may be continuously rotated as the first meal ingredient portion 302A is dispensed. Accordingly, as shown in FIG. 6C, the first meal ingredient portion 302A has also been dispensed into the third region C and then the second region B. In some embodiments, the meal receptacle holder 400 may rotate the meal receptacle 200 a full revolution (e.g., 360 degrees) to dispense a meal ingredient into all regions of the meal receptacle, where the regions are quadrants. In some embodiments, the meal receptacle holder 400 may rotate the meal receptacle 200 a half revolution (e.g., 180 degrees) to dispense a meal ingredient into two regions of the meal receptacle, where the regions are quadrants. In some embodiments, the meal receptacle holder 400 may rotate the meal receptacle 200 a three-quarters revolution (e.g., 270 degrees) to dispense a meal ingredient into three regions of the meal receptacle, where the regions are quadrants. Depending on the particular regions for a meal receptacle and meal order, any rotation may be made during or prior to a meal ingredient dispenser dispensing a meal ingredient, as the present disclosure is not so limited.

It should be noted that while in the example of FIGS. 6B-6C the meal receptacle 200 was rotated in a first direction (e.g., clockwise relative to the page), in other embodiments a meal receptacle may be rotated in a second direction (e.g., counterclockwise relative to the page). In some embodiments, a meal receptacle holder may move a meal receptacle in a first direction or a second direction in a second degree of freedom depending on the speed with which a target region of the meal receptacle 200 can be aligned with a meal ingredient dispenser. For example, taking the state of FIG. 6A, if a target region for a first meal ingredient portion is region B, the meal receptacle holder may rotate the meal receptacle 200 in the second direction (e.g., counterclockwise) so that the region B is more quickly aligned with the first meal ingredient dispenser 110A compared to a rotation in the first direction. In contrast, if a target region for a meal ingredient portion is region C, the meal receptacle holder may rotate the meal receptacle 200 in the first direction (e.g., clockwise) so that the region C is more quickly aligned with the first meal ingredient dispenser 110A compared to a rotation in the second direction. A controller of the meal receptacle holder 400 may command an actuator of the meal receptacle holder to rotate a meal receptacle in a direction that has a smaller angle of rotation required to align a target region to a meal ingredient dispenser. In some embodiments, a meal receptacle holder 400 may rotate a meal receptacle in a single direction in a rotational degree of freedom.

FIG. 6D is a top schematic of the meal receptacle holder 400 and a meal production system in a fourth state of an embodiment of a meal production process. In the state of FIG. 6D, the first meal ingredient dispenser 110A has finished dispensing the first meal ingredient portion 302A. As a result of the rotation of the meal receptacle 200 described above, the first meal ingredient portion 302A is disposed in the first region A, second region B, third region C, and fourth region D. As discussed above, the meal receptacle 200 was rotated in the second direction to make a full revolution while the first meal ingredient portion 302A was dispensed. After the first meal ingredient portion 302A was dispensed, the chassis 410 moved along the track 140 in the first degree of freedom to align the meal receptacle 200 with a second meal ingredient dispenser 110B shown in phantom for clarity. Specifically, as shown in FIG. 6D, the first region A of the meal receptacle 200 is aligned with the second meal ingredient dispenser 110B. In FIG. 6D the second meal ingredient dispenser 110B has dispensed a second meal ingredient portion 302A into the first region A.

In some embodiments, the chassis 410 of the meal receptacle holder 400 may stop on the track 140 once a target region of the meal receptacle is able to be aligned with a meal ingredient dispenser (e.g., second meal ingredient dispenser 110B). In the case of the transition between FIG. 6C and FIG. 6D, the meal receptacle may be in the correct orientation with respect to the second degree of freedom, such that that meal receptacle 200 does not need to be moved in the second degree of freedom to align the target region with a meal ingredient dispenser. In the orientation shown in FIG. 6D, the first region A and the second region D may be aligned with the second meal ingredient dispenser 110B by moving in the first degree of freedom along the track without rotating the meal receptacle 200. Accordingly, in some cases only movement of the chassis 410 on the track 140 may be employed to align a target region of the meal receptacle 200 with a meal ingredient dispenser. For example, as shown in FIG. 6E, after the second meal ingredient dispenser 110B dispensed the second meal ingredient portion 302B into the first region A, the chassis 410 moved along the track 140 in the first degree of freedom to align the fourth region D with a third meal ingredient dispenser 110C (shown in phantom for clarity). The meal receptacle 200 was not moved by the meal receptacle holder 400 in the second degree of freedom to allow the fourth region D to be aligned with the third meal ingredient dispenser 110C. As shown in FIG. 6E, a third meal ingredient portion 302C is dispensed into the fourth region D.

FIG. 6F is a top schematic of the meal receptacle holder 400 of FIG. 4 and a meal production system in a sixth state of an embodiment of a meal production process. From the state shown in FIG. 6E, the chassis 410 moves along the track to align the meal receptacle 200 with a fourth meal ingredient dispenser 110D (shown in phantom for clarity). Specifically, as shown in FIG. 6F, the meal receptacle holder 400 is configured to align the second region B and the third region C with the fourth meal ingredient dispenser 110D so that a fourth meal ingredient portion 302D may be dispensed into those regions. In some embodiments, the chassis 410 may move along the track from the state shown in FIG. 6E until the first region A is aligned with the fourth meal ingredient dispenser 110D. Once the first region A is aligned with the fourth meal ingredient dispenser 110D, the chassis 410 may stop. Once stopped, the meal receptacle holder 400 may rotate the meal receptacle 200 in a second direction in the second degree of freedom (e.g., counterclockwise relative to the page). In some embodiments, while the meal receptacle 200 is rotating, the fourth meal ingredient dispenser 110D may dispense the fourth meal ingredient portion 302D into the second region B and the third region C once those regions are respectively aligned with the fourth meal ingredient dispenser 110D. In some embodiments, the meal receptacle holder 400 may stop the meal receptacle when each of the second region B and the third region C are aligned with the fourth meal ingredient dispenser 110D. For example, the meal receptacle holder 400 may make a first rotation of the meal receptacle in the second direction to align the second region B with the fourth meal ingredient dispenser 110D and stop to allow the fourth meal ingredient portion 302D to be dispensed into the second region B. In this example, next the meal receptacle holder 400 may make a second rotation of the meal receptacle in the second direction to align the third region C with the fourth meal ingredient dispenser 110D and stop to allow the fourth meal ingredient portion 302D to be dispensed into the third region C. Accordingly, continuous rotation of a meal receptacle during dispensing or sequential rotations in between dispensing cycles may be employed to dispense a meal ingredient portion into one or more regions of a meal receptacle, as the present disclosure is not so limited.

In some embodiments, as described with reference to FIGS. 6A-6F, in some embodiments a chassis 410 may move to an appropriate position on a track 140 in a first degree of freedom before a meal receptacle holder 400 moves a meal receptacle 200 in a second degree of freedom. In other embodiments, a meal receptacle holder may move a meal receptacle in a first degree of freedom and second degree of freedom simultaneously. For example, as a meal receptacle holder moves a meal receptacle from a first meal ingredient dispenser 110A to a second meal ingredient dispenser 110B and a target region requires movement of a meal receptacle in both degrees of freedom, the meal receptacle holder may move the meal receptacle in both degrees of freedom to reduce the time taken to align a region of the meal receptacle with a meal ingredient dispenser, thereby improving meal production system throughput. In other embodiments, a meal receptacle may be moved in a second degree of freedom (e.g., rotation) prior to movement of the chassis in the first degree of freedom (e.g., translation along the track).

In some embodiments, as described with reference to FIGS. 6A-6F, a meal may be assembled by dispensing meal ingredient portions from one or more meal ingredient dispensers. In some embodiments, a series of meal ingredient dispensers may dispense meal ingredient portions sequentially. In some embodiments, a meal production system may include a plurality of meal ingredient dispensers, and one meal ingredient dispenser or a subset of the meal ingredient dispensers may dispense meal ingredient portions as a part of a meal production process. For example, a meal production system may include a variety of meal ingredients, and not all meal ingredients may be dispensed to form a meal. Such an arrangement may allow one meal production system to prepare a variety of different meals having different meal ingredients.

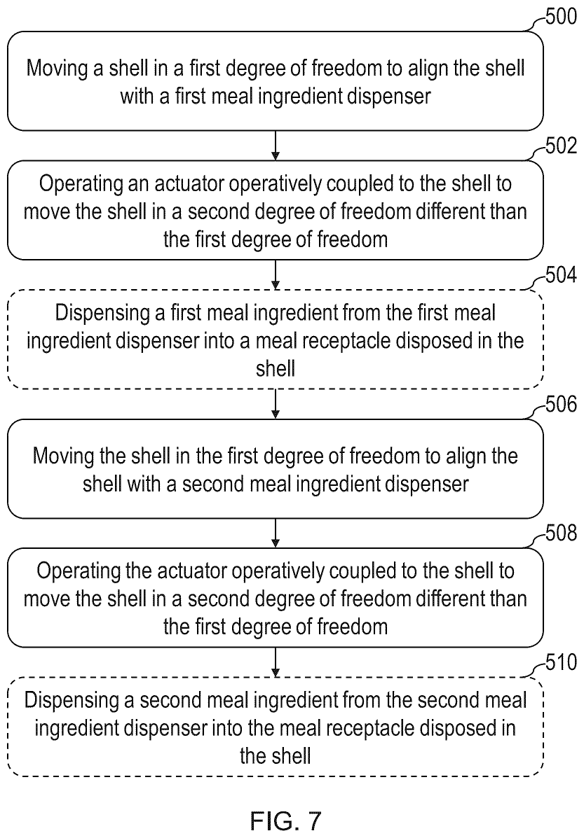

FIG. 7 is a flow chart for an embodiment of a method of operating a meal production system. In block 500, a shell is moved in a first degree of freedom to align the shell with a first meal ingredient dispenser. In some embodiments, the first degree of freedom may be provided by a track. The shell may be a component of a meal receptacle holder operatively coupled to an actuator disposed on the meal receptacle holder. The shell may support a meal receptacle with receives a meal ingredient from one or more meal ingredient dispensers. In block 502, the actuator may be operated to move the shell in a second degree of freedom different than the first degree of freedom. The actuator may be configured to move the shell relative to a chassis of the meal receptacle holder. For example, the second degree of freedom may be a rotational degree of freedom, and the actuator may rotate the shell. As another example, the second degree of freedom may be a translational degree of freedom, and the actuator may move the shell perpendicular to a track. Moving the shell in the first degree of freedom and the second degree of freedom may allow one or more regions of the meal receptacle to be aligned with a meal ingredient dispenser. In some embodiments, the regions may be disposed in two-dimensional plane, and movement of the shell in the first degree of freedom and the second degree of freedom may allow the shell to be moved parallel to the two-dimensional plane so that a target region may be aligned with a meal ingredient dispensers. In optional block 504, a first meal ingredient may be dispensed from the first meal ingredient dispenser into a meal receptacle disposed in the shell.

In the embodiment of FIG. 7, the method further includes, in block 506, moving the shell in the first degree of freedom to align the shell with a second meal ingredient dispenser. As noted previously, moving in the first degree of freedom may include moving a meal receptacle holder along a track. In block 508, the actuator is operated to move the shell in the second degree of freedom. In optional bloc 510, a second meal ingredient may be dispensed from the second meal ingredient dispenser into a meal receptacle disposed in the shell.

FIG. 8 is a first side schematic and FIG. 9 is a second side schematic of an embodiment of a charger 600 of a meal production system. The charger of FIG. 8 may be configured to charge a power source onboard a meal receptacle holder (for example, see FIGS. 4-5). As discussed previously, the inventors have appreciated the benefits of a meal receptacle holder having an onboard power source so that a meal receptacle holder may operate independently on a track with no hardwired power or data connections. In some embodiments, the inventors have appreciated that it may be desirable to charge a meal receptacle holder every cycle around a track circuit. For example, in the case of a power source for metal receptacle holder being a capacitor, such an arrangement may ensure the meal receptacle holder has enough power to complete a track circuit. Additionally, the inventors have appreciated the benefits of a charger system that may operate autonomously, without having user interaction to charge a meal receptacle holder. The exemplary charger of FIG. 8-9 may be configured to charge a meal receptacle holder at a designating charging position on a track.

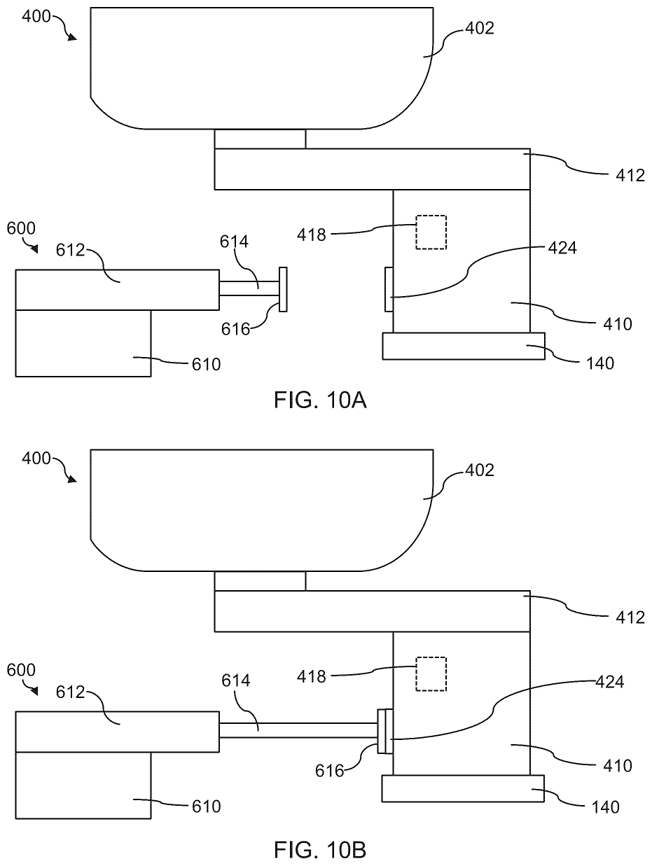

As shown in FIGS. 8-9, the charger includes a charger chassis 610 which may be configured to be mounted to a portion of a meal production system adjacent a track. The chassis supports a charging actuator 612. In the embodiment of FIGS. 8-9, the charger may be a linear actuator. The actuator 612 may be pneumatic actuator or another suitable actuator in other embodiments, as the present disclosure is not so limited. The charging actuator 612 has two output shafts 614 in the embodiment of FIGS. 8-9. In other embodiments, an actuator of a charger may include a single output shaft or any number of output shafts, as the present disclosure is not so limited. As shown in FIGS. 8-9, the charger includes a first charger surface 616A and a second charger surface 616B (e.g., at least two charger surfaces). The first and second charger surfaces may be configured to move into contact with corresponding contact surfaces of a meal receptacle holder (for example, see FIGS. 4-5). The actuator 612 is configured to move the first charger surface 616A and the second charger surface 616B between an engaged position and a disengaged position to engage or disengage contact surfaces on a meal receptacle holder, respectively. Such an exemplary process is described further with reference to FIGS. 10A-10B. In some embodiments, the charger surfaces 616A, 616B may be flat and configured to make flush contact with corresponding contact surfaces to form an electrical connection. In other embodiments, a charger surface may be spring loaded or have any suitable shape to promote consistent and repeatable electrical contact between a charger and meal receptacle holder. For example, a charger surface may be spring loaded so that a consistent contact force is applied between the charger surface and a corresponding contact surface of a meal receptacle holder.

FIG. 10A is a side schematic of the charger of FIG. 8 and a meal receptacle holder in a first state of an embodiment of a meal production process, and FIG. 10B is a side schematic of the charger and meal receptacle holder in a second state of the meal production process. FIGS. 10A-10B depict stages of charging process for a meal receptacle holder 400. As shown in FIGS. 10A-10B, a meal receptacle holder 400 includes a chassis 410 disposed on a track 140. The chassis includes a power source 418 and at least one contact surface 424 (e.g., at least two contact surfaces). The meal receptacle holder also includes a shell 402 supported on a cantilevered arm 412. As discussed with reference to other embodiments herein, an actuator of the meal receptacle holder may move the shell 402 in a degree of freedom different than a degree of freedom provided by the track 140. The actuator may be powered by the power source 418, which in some embodiments may be a capacitor. In other embodiments, the power source 418 may be a battery.

In the embodiment of FIGS. 10A-10B, the charger may include a chassis 610, an actuator 612, and at least one charger surface 616 (e.g., at least two charger surfaces). The at least one charger surface 616 may be coupled to an output shaft 614 of the actuator 612. The actuator may be configured to move the at least on charger surface 616 between an engaged position and a disengaged position to move the at least one charger surface 616 into or out of contact with the at least one contact surface 424. The at least one charger surface 616 may be electrically connected to a power source (for example, a building power source) so that electrical energy may be transmitted through the at least one charger surface to charge the power source 418 of the meal receptacle holder 400.

According to the embodiment of FIGS. 10A-10B, the charger 600 is disposed adjacent the track 140 in a charging position. In some embodiments, a single charger 600 may be employed for a meal production system and is configured to charge the power source 418 of a plurality of meal receptacle holders 400. In other embodiments, multiple chargers may be employed at multiple charging positions so that multiple meal receptacle holders may be charged at the same time. In some embodiments, the track 140 may be a circuit, such that each meal receptacle holder 400 crosses the charging position every circuit of the track. In the charging position, the at least one charger surface 616 is aligned with the at least one contact surface 424 with respect to a direction of movement of the at least one charger surface. That is, when in the charging position, the at least one charger surface 616 may be moved by the actuator 612 to move into or out of contract with the at least one contact surface 424. As shown in FIG. 10A, the at least one charger surface 616 is in a disengaged position and is out of contact with the at least one contact surface 424. In FIG. 10B, the actuator 612 has moved the at least one charger surface 616 to an engaged position so that the at least one charger surface is in contact with the at least one contact surface 424. In the state shown in FIG. 10B, the charger 600 may transfer electrical energy to the power source 418 via the at least one charger surface 616 and the at least one contact surface 424, and one or more optional components such as a charge controller. In some embodiments as shown in FIG. 10A-10B, the charger 600 may be configured to move the at least one charger surface 616 in a direction perpendicular to a direction the meal receptacle holder 400 moves on the track 140.

While in the embodiment of FIGS. 10A-10B the charger includes an actuator and is configured to move at least one charger surface 616 between an engaged position and a disengaged position, in other embodiments a charger may have no moving components. For example, the charger may include at least one charger surface that is are configured to move into contact with the at least one contact surface as the chassis 410 moves into a charging position. For example, the at least one charger surface may be configured to be slidingly engaged by the at least one contact surface 424 as the chassis 410 moves along the track 140 without the at least one charger surface being actively moved by a charger actuator. In some such embodiments, the at least one charger surface may be resilient or otherwise biased into an engaged position, so that the at least one charger surface may be moved by the meal receptacle holder as the meal receptacle holder moves into the charging position.

While in the embodiment of FIGS. 10A-10B a charger is configured to engage at least one contact surface 424 disposed on a side of the chassis 410 facing a direction in which the cantilevered arm 412 extends, other arrangements may be employed. For example, the at least one contact surface 424 may be disposed on an opposite side of the chassis, facing away from the direction in which the cantilevered arm extends. Additionally, which in the embodiment of FIGS. 10A-10B the at least one contact surface 424 is disposed on a chassis 410 of the meal receptacle holder 400, the at least one contact surface 424 may be disposed on another portion of the meal receptacle holder, as the present disclosure is not so limited.

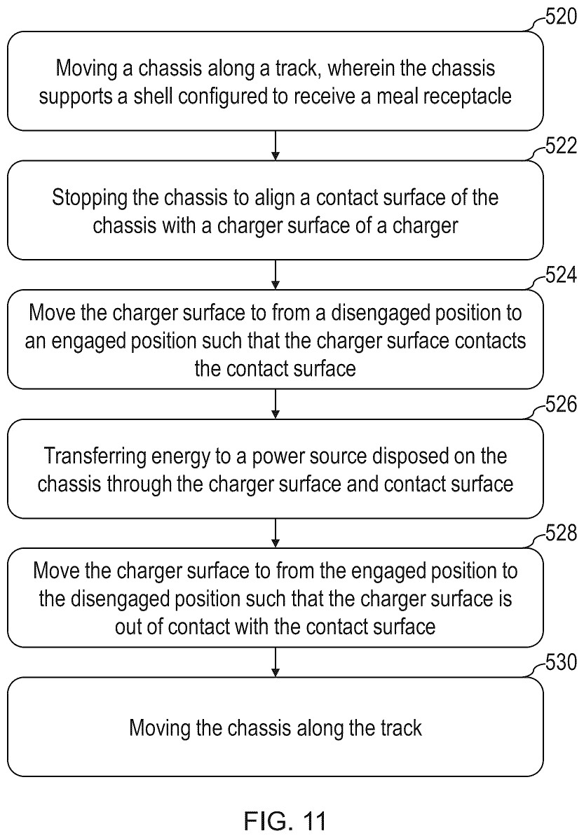

FIG. 11 is a flow chart for an embodiment of a method of operating a meal production system. In block 520, a chassis of a meal receptacle holder is moved along a track. The chassis supports a shell configured to receive a meal receptacle. In block 522, the chassis may be stopped to align a contact surface of the chassis with a charger surface of a charger. In block 524, the charger surface may be moved from a disengaged position, where the charger surface is not in contact with the contact surface, to an engaged position so that the charger surface contacts the contact surface. In block 526, energy (e.g., electrical energy) may be transferred to a power source disposed on the chassis through the charger surface and the contact surface. In block 528, the charger surface is moved from the engaged position to the disengaged position so that the charger surface is out of contact with the contact surface. In block 530, the chassis may be moved along the track. In some embodiment, the chassis may continue along the track in the same direction as in block 520.

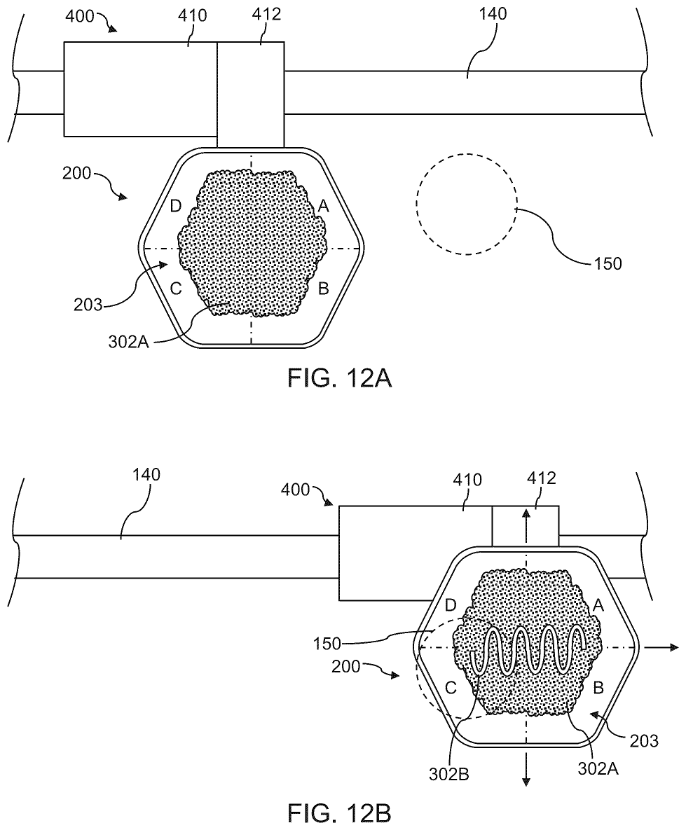

FIG. 12A is a top schematic of an embodiment of a meal receptacle holder in a first state of an embodiment of a meal production process, and FIG. 12B depicts the meal receptacle holder in a second state of an embodiment of a meal production process. The meal receptacle holder of FIGS. 12A-12B is configured to move a meal receptacle 200 in a first degree of freedom and a second degree of freedom to allow a target region of a meal receptacle to be aligned with a meal ingredient dispenser such as a liquid meal ingredient dispenser 150 (shown in phantom for clarity). Accordingly, a meal ingredient may be dispensed into an interior volume 203 of the meal receptacle 200 in one or more target regions. In the embodiment of FIGS. 12A-12B, the first degree of freedom is provided by movement along a track 140. Specifically, a chassis 410 of the meal receptacle holder 400 is configured to move along the track 140. Additionally, the meal receptacle holder includes an actuator configured to move a shell (for example, see FIG. 4) supporting the meal receptacle 200. In the embodiment of FIGS. 12A-12B, the second degree of freedom may be a translational degree of freedom. For example, the actuator may be a linear actuator configured to move the meal receptacle 200 linearly relative to the chassis 410. In some embodiments, the meal receptacle holder 400 of FIGS. 12A-12B may move the meal receptacle 200 in a direction perpendicular to the track 140. Thus, in some embodiments, the first degree of freedom and second degree of freedom may be perpendicular translational degrees of freedom. In other embodiments, the second degree of freedom may be transverse to the first degree of freedom, but not perpendicular.

According to the embodiment of FIGS. 12A-12B, a translational second degree of freedom may allow meal ingredients to be dispensed in target regions of a meal receptacle. For example, meal receptacle 200 includes a first region A, second region B, third region C, and fourth region D. As discussed in reference to other exemplary embodiments herein, movement of a meal receptacle 200 may allow a specific region to be aligned with a meal ingredient dispenser in a two-dimensional plane to allow that meal ingredient to be dispensed to that target region. In some embodiments, movement in the second degree of freedom during a dispensing of a meal ingredient may allow a meal ingredient to be dispensed into multiple regions or in a desired pattern or effect. Dispensing a meal ingredient in a desired pattern may be desirable for some meal ingredients like liquid meal ingredients. For example, it may be desirable to dispense a sauce across multiple meal ingredients that promotes even distribution of the sauce within the interior volume 203 of the meal receptacle 200. In some embodiments, a meal receptacle 200 may be moved simultaneously in the first degree of freedom and the second degree of freedom to provide a desired pattern of meal ingredient in the meal receptacle.

As shown in FIG. 12A, a first meal ingredient portion 302A has been dispensed into all regions of the meal receptacle 200. The chassis 410 of the meal receptacle holder 400 may be moved along the track 140 to align the meal receptacle 200 with the liquid meal ingredient dispenser 150. As shown in FIG. 12B, in the depicts example, the meal receptacle 200 may be moved continuously in the first degree of freedom and the second degree of freedom while the second meal ingredient portion 302B (in this case, a liquid meal ingredient) is dispensed into the meal receptacle 200. For the meal of FIGS. 12B, the meal production system is configured to dispense the second meal ingredient portion 302B in a wave pattern. Accordingly, as the chassis 410 moves along the chassis in a first direction (e.g., right relative to the page), the actuator of the meal receptacle holder may move the meal receptacle 200 in a second direction and third direction in the second degree of freedom, as shown by the arrows perpendicular to a longitudinal axis of the track 140. The meal receptacle may oscillate between two positions in the second degree of freedom. As a result, during a continuous dispense of the second meal ingredient portion 302B, a sinusoidal wave pattern may be formed in the meal receptacle 200. Other patterns may be provided in a similar manner by moving the meal receptacle 200 in a first degree of freedom and/or second degree of freedom while meal ingredient dispenser dispenses a meal ingredient, including, but not limited to, square waves, sawtooth waves, circles, and straight lines.

It should be noted that while in the embodiment of FIGS. 12A-12B, the second degree of freedom is translational and allows patterns to be dispensed into a meal receptacle, a rotational degree of freedom as described with reference to FIGS. 6A-6F may also be used to dispense meal ingredients in patterns in a meal receptacle 200. For example, a meal receptacle may be rotated in a rotational degree of freedom in two directions while a meal ingredient is dispensed to provide a sinusoidal wave pattern like that shown in FIG. 12B. For example, the meal receptacle may be oscillated between a first rotational position and a second rotational position while moving along the track. A meal receptacle holder providing a first translational degree of freedom (e.g., along a track) and second rotational degree of freedom may allow for dispensing one or more patterns into a meal receptacle, including, but not limited to, sinusoidal waves, square waves, sawtooth waves, circles, straight lines.

In some embodiments, a meal receptacle holder may provide three degrees of freedom. For example, a first degree of freedom may be provided by a track, a second degree of freedom may be a rotational degree of freedom, and a third degree of freedom may be a translational degree of freedom transverse (e.g., perpendicular) to the first degree of freedom. The second and third degrees of freedom may be redundant to enable movement in a two-dimensional plane, but in some cases may allow a meal receptacle to be more quickly positioned to align a region of the meal receptacle with a meal ingredient dispenser. Additionally, such an arrangement may allow more complex patterns to be provided with a dispensed meal ingredient, as simultaneous movement in all three degrees of freedom may be provided.

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the embodiments described herein may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present disclosure as discussed above. As used herein, the term “computer-readable storage medium” encompasses only a non-transitory computer-readable medium that can be considered to be a manufacture (i.e., article of manufacture) or a machine. Alternatively, or additionally, the disclosure may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present disclosure as discussed above. Additionally, it should be appreciated that according to one aspect of this embodiment, one or more computer programs that when executed perform methods of the present disclosure need not reside on a single computer or processor but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

A controller including one or more processors may communicate with one or more actuators using any suitable communication protocol. For example, a controller may communicate with one or more actuators and/or sensors via serial, I2C, SPI, CAN, and/or any other appropriate protocol. A controller may receive one or more inputs from one or more users. In some cases, the one or more inputs may be associated with pre-stored computer readable instructions stored on non-volatile memory. Accordingly, the one or more inputs may instruct the controller to execute one or more sets of computer readable instructions associated with the inputs. The controller may communicate with and control one or more actuators to execute the computer readable instructions.

Various aspects of the present disclosure may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. A meal receptacle holder for a meal production system, comprising:
a shell configured to receive and support a meal receptacle;
a chassis configured to be operatively coupled to a track such that the shell moves along the track in a first degree of freedom; and
an actuator operatively coupled to the chassis and the shell, wherein the actuator is configured to move the shell in a second degree of freedom different than the first degree of freedom.

2. The meal receptacle holder of claim 1, wherein the first degree of freedom is a translational degree of freedom, and wherein the second degree of freedom is a rotational degree of freedom.

3. The meal receptacle holder of claim 2, wherein the shell is configured to transmit torque to a meal receptacle received in the shell, such that movement of the shell in the second degree of freedom rotates the meal receptacle received in the shell.

4. The meal receptacle holder of claim 1, wherein the first degree of freedom is a translational degree of freedom, and wherein the second degree of freedom is a translational degree of freedom in a direction perpendicular to the first degree of freedom.

5. The meal receptacle holder of claim 1, further comprising a cantilevered arm supporting the shell, wherein the chassis supports the cantilevered arm.

6. The meal receptacle holder of claim 5, wherein the actuator is disposed in the cantilevered arm.

7. The meal receptacle holder of claim 5, further comprising a transmission, wherein the actuator is disposed in the chassis, wherein the transmission is disposed in the cantilevered arm, and wherein the transmission operatively couples the actuator to the shell.

8. The meal receptacle holder of claim 7, wherein the actuator is a servo comprising an output shaft aligned with a first axis, wherein the second degree of freedom of the shell is rotation about a second axis parallel to the first axis.

9. The meal receptacle holder of claim 1, further comprising a power source disposed on the chassis configured to supply power to the actuator.

10. The meal receptacle holder of claim 9, wherein the power source is a battery or a capacitor.

11. The meal receptacle holder of claim 10, further comprising at least two contact surfaces disposed on the chassis, wherein the at least two contact surfaces are configured to receive corresponding charger surfaces of the meal production system to charge the battery or the capacitor.

12. The meal receptacle holder of claim 1, further comprising a controller configured to coordinate movement of the shell in the first degree of freedom and the second degree of freedom.

13. The meal receptacle holder of claim 12, further comprising a transceiver in communication with the controller, wherein the transceiver is configured to communicate with another controller of the meal production system.

14. A meal production system comprising:
a plurality of meal receptacle holders, wherein each of the plurality of meal receptacle holders comprises:
a shell configured to receive and support a meal receptacle, and
an actuator operatively coupled the shell, wherein the actuator is configured to move the shell in a first degree of freedom; and
a track supporting the plurality of meal receptacle holders, wherein the track is configured to move the plurality of meal receptacle holders along the track in a second degree of freedom different than the first degree of freedom.

15. The meal production system of claim 14, wherein the track is configured to independently move each of the plurality of meal receptacle holders in the first degree of freedom.

16. The meal production system of claim 14, wherein the first degree of freedom is a rotational degree of freedom, and wherein the second degree of freedom is a translational degree of freedom.

17. The meal production system of claim 16, wherein the shell is configured to transmit torque to a meal receptacle received in the shell, such that movement of the shell in the first degree of freedom rotates the meal receptacle received in the shell.

18. The meal production system of claim 14, wherein the first degree of freedom is a translational degree of freedom, and wherein the second degree of freedom is a translational degree of freedom in a direction perpendicular to the first degree of freedom.

19. The meal production system of claim 14, wherein each of the plurality of meal receptacle holders further comprises a chassis and a cantilevered arm supporting the shell, wherein the chassis supports the cantilevered arm.

20. The meal production system of claim 19, further comprising a transmission, wherein the actuator is disposed in the chassis, wherein the transmission is disposed in the cantilevered arm, and wherein the transmission operatively couples the actuator to the shell.

21. The meal production system of claim 20, wherein the actuator is a servo comprising an output shaft aligned with a first axis, wherein the second degree of freedom of the shell is rotation about a second axis parallel to the first axis.

22. The meal production system of claim 14, wherein each of the plurality of meal receptacle holders further comprises a power source configured to supply power to the actuator.

23. The meal production system of claim 22, wherein the power source is a battery or a capacitor.

24. The meal production system of claim 23, further comprising at least two charger surfaces, wherein each of the plurality of meal receptacle holders further comprises at least two contact surfaces, wherein the at least two contact surfaces are configured to receive the at least two charger surfaces to charge the battery or the capacitor.

25. The meal production system of claim 24, further comprising a charging actuator configured to move the at least two charger surfaces between an engaged position and a disengaged position, wherein in the engaged position the at least two charger surfaces are configured to contact the at least two contact surfaces, and wherein in the disengaged position the at least two charger surfaces are configured to be out of contact with the at least two contact surfaces.

26. The meal production system of claim 25, wherein movement of the at least two charger surfaces between the engaged position and the disengaged position is in a direction perpendicular to the second degree of freedom.

27. The meal production system of claim 14, further comprising at least one meal ingredient dispenser positioned above the track, wherein the shell includes a plurality of regions configured to be aligned with the at least one meal ingredient dispenser to receive a meal ingredient, wherein the actuator is configured to move the shell in the first degree of freedom and the track is configured to move the shell in the second degree of freedom to align one or more regions of the plurality of regions with the at least one meal ingredient dispenser.

28. The meal production system of claim 27, further comprising a first controller associated with the track, wherein each of the plurality of meal receptacle holders comprises a second controller, wherein the first controller is configured to coordinate movement of the plurality of meal receptacle holders along the track in the second degree of freedom, and wherein the second controller is configured to coordinate movement of a respective meal receptacle holder in the first degree of freedom.

29. The meal production system of claim 28, wherein the first controller is configured to control dispensing of meal ingredients from the at least one meal ingredient dispenser into one or more regions of the plurality of regions when the one or more regions are aligned with the at least one meal ingredient dispenser.

30. The meal production system of claim 28, wherein each of the plurality of meal receptacle holders comprises a transceiver in communication with the first controller.

31. The meal production system of claim 27, wherein the plurality of regions are arrayed in at least one column corresponding to the first degree of freedom and at least one row perpendicular to the at least one column.

32. A method of operating a meal production system, comprising:
moving a shell configured to receive and support a meal receptacle in a first direction in a first degree of freedom along a track to align the shell with a meal ingredient dispenser; and
moving the shell with an actuator in a second degree of freedom different than the first degree of freedom while the shell is aligned with the meal ingredient dispenser.

33. The method of claim 32, wherein the first degree of freedom is a translational degree of freedom, and wherein the second degree of freedom is a rotational degree of freedom.

34. The method of claim 33, further comprising transmitting torque to a meal receptacle received in the shell, such that movement of the shell in the second degree of freedom rotates the meal receptacle received in the shell.

35. The method of claim 32, wherein the first degree of freedom is a translational degree of freedom, and wherein the second degree of freedom is a translational degree of freedom in a direction perpendicular to the first degree of freedom.

36. The method of claim 32, wherein moving the shell in the first direction comprises moving a chassis and a cantilevered arm supporting the shell along the track, wherein the chassis supports the cantilevered arm.

37. The method of claim 36, wherein the actuator is disposed in the cantilevered arm.

38. The method of claim 36, wherein moving the shell in the second degree of freedom comprises transmitting force from the actuator to the shell via a transmission, wherein the actuator is disposed in the chassis, wherein the transmission is disposed in the cantilevered arm.

39. The method of claim 38, wherein the actuator is a servo comprising an output shaft aligned with a first axis, wherein the second degree of freedom of the shell is rotation about a second axis parallel to the first axis.

40. The method of claim 36, further comprising powering the actuator with a power source disposed on the chassis.

41. The method of claim 40, wherein the power source is a battery or a capacitor.

42. The method of claim 41, further comprising receiving, at a contact surface disposed on the chassis, a corresponding charger surface of the meal production system to charge the battery or the capacitor.
